(19) United States
(12) Patent Application Publication
(10) Pub. No.: US 2008/0229190 A1
(43) Pub. Date: Sep. 18, 2008

(54) SYSTEM AND METHOD OF PROVIDING AN E-BOOK

(76) Inventor: Byron Johnson, Chicago, IL (US)

Correspondence Address: HOLLAND & KNIGHT LLP, 10 ST. JAMES AVENUE, 11th Floor, BOSTON, MA, 02116-3889, US

(21) Appl. No.: 12/028,357

(22) Filed: Feb. 8, 2008

Related U.S. Application Data
(60) Provisional application No. 60/894,535, filed on Mar. 13, 2007.

(51) Int. Cl. G06F 17/00

(52) U.S. Cl. 715/238

(57) ABSTRACT

A system and method for providing an electronic book including rendering an electronic book viewable by a user. The electronic book system may include at least one interactive complementary feature related to at least a portion of a content of the electronic book and the at least one interactive complementary feature may be accessible to the user.

### CROSS-REFERENCE TO RELATED APPLICATIONS

This application claims the benefit of U.S. provisional patent application Ser. No. 60/894,535, filed Mar. 13, 2007, the entire disclosure of which is incorporated by reference.

### FIELD OF THE INVENTION

The present invention relates to books, and more specifically to a system and method for providing an electronic book.

### BACKGROUND

Many tools and programs exist for helping students learn. Often, these tools require access to multiple learning accessories such as a calculator, a map, a copy of the periodic table of elements and other such learning accessories that may better help the student understand the subject he is studying. Carrying all of these learning accessories around may be cumbersome, and any accessories may get lost, damaged or otherwise become unavailable for use by the student.

Similarly, carrying many books around can be cumbersome and some of the books may be lost or damaged. Additionally, some students may struggle with reading and may find that reading from a lengthy text can be an intimidating task. There exists a need for a teaching tool that includes any learning accessories that may be implemented by a student studying a particular subject, as well as a tool that enables the student to access multiple books.

### SUMMARY

According to an implementation, an electronic book system may include an electronic book viewable by a user. The electronic book system may include at least one interactive complementary feature related to at least a portion of a content of the electronic book and the at least one interactive complementary feature may be accessible to the user.

One or more of the following features may be included. The electronic book may be selected from a user-specific list of electronic books. The at least one interactive complementary feature may be selected from the group consisting of a calculator, a graphing calculator, a dictionary, a thesaurus, a periodic table, a timeline, a map, a set of maps, and a table of equations. The at least one interactive complementary accessory feature may be selected from a list of interactive complementary features related to at least a portion of the content of the electronic book and accessible to the user. A bookmarking function may be included, the bookmarking function enabling a user to bookmark a stopping point in the electronic book for returning to at a later time.

According to another implementation, a method for providing an electronic book may include rendering an electronic book on a display screen of a computing device. An interactive complementary feature request may be received from a user. At least one interactive complementary feature related to at least a portion of a content of the electronic book may be rendered in response to the interactive complementary feature request.

One or more of the following features may be included. The electronic book may be selected from a user-specific list of electronic books. The at least one interactive complementary feature may be selected from the group consisting of a calculator, a graphing calculator, a dictionary, a thesaurus, a periodic table, a timeline, a map, a set of maps, and a table of equations. The at least one interactive complementary feature may be selected from a list of interactive complementary features related to at least a portion of the content of the electronic book and accessible to the user. A bookmarking function may be provided, the bookmarking function enabling a user to bookmark a stopping point in the electronic book for returning to at a later time.

According to a third implementation, a computer program product residing on a computer readable medium having a plurality of instructions stored thereon which, when executed by a processor, cause the processor to perform operations including rendering an electronic book on a display screen of a computing device. The computer program product also includes instructions for receiving an interactive complementary feature request from a user. The computer program product also includes instructions for rendering at least one interactive complementary feature related to at least a portion of a content of the electronic book in response to the interactive complementary feature request.

One or more of the following features may be included. The electronic book may be selected from a user-specific list of electronic books. The at least one interactive complementary feature may be selected from the group consisting of a calculator, a graphing calculator, a dictionary, a thesaurus, a periodic table, a timeline, a map, a set of maps, and a table of equations. The at least one interactive complementary feature may be selected from a list of interactive complementary features related to at least a portion of the content of the electronic book and accessible to the user. The computer program product may also include instructions for providing a bookmarking function, the bookmarking function enabling a user to bookmark a stopping point in the electronic book for returning to at a later time.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an e-book provision process coupled to a distributed computing network

FIG. 2 is a flowchart of a process executed by the e-book provision process of FIG. 1.

FIG. 3 diagrammatically depicts a user interface screen rendered by the e-book provision process and/or client application of FIG. 1.

FIG. 4 diagrammatically depicts a user interface screen rendered by the e-book provision process and/or client application of FIG. 1.

FIG. 5 diagrammatically depicts a user interface screen rendered by the e-book provision process and/or client application of FIG. 1.

FIG. 6 diagrammatically depicts a user interface screen rendered by the e-book provision process and/or client application of FIG. 1.

FIG. 7 diagrammatically depicts a user interface screen rendered by the e-book provision process and/or client application of FIG. 1.

### DETAILED DESCRIPTION

### System Overview:

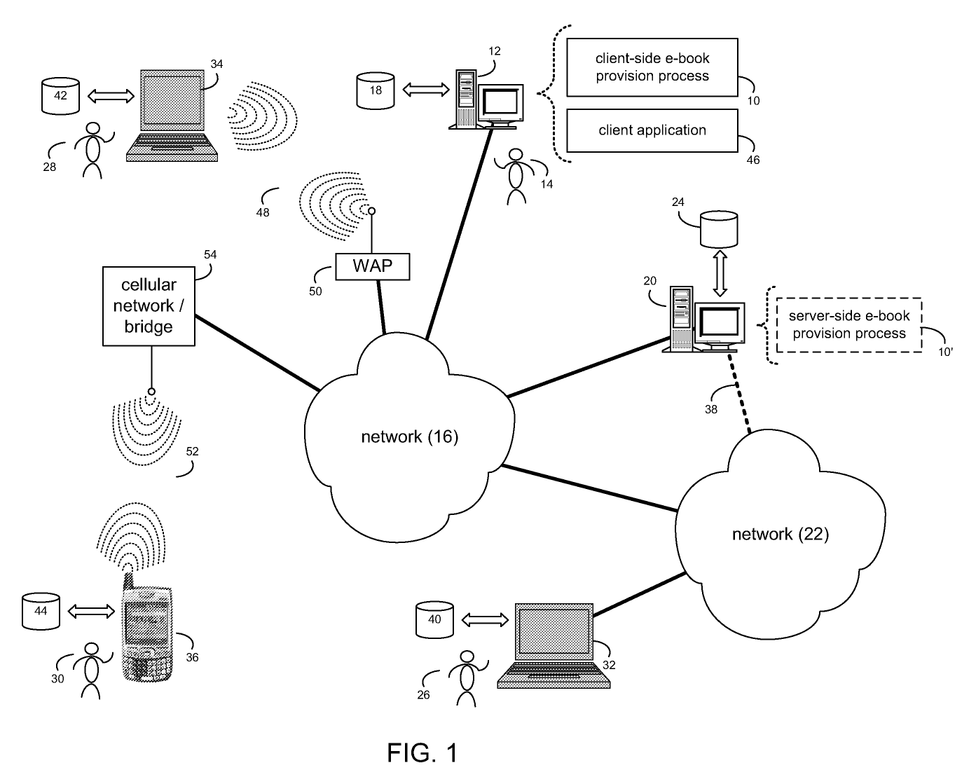

Referring to FIG. 1, there is shown an e-book provision process 10 that may provide an electronic book, viewable by a user, and at least one interactive complementary feature related to the electronic book and accessible to the user. E-book provision process 10 may reside on and may be executed by a computing device (e.g., personal computer 12). As will be discussed below in greater detail, e-book provision process 10 may enable a student (e.g., user 14) to select an electronic book for reading and to access interactive complementary features.

E-book provision process 10 may be a client-side application that resides on and is executed by a computing device, e.g., personal computer 12, which may be connected to network 16 (e.g., the Internet). The instruction sets and subroutines of e-book provision process 10, which may be stored on a storage device 18 coupled to personal computer 12, may be executed by one or more processors (not shown) and one or more memory architectures (not shown) incorporated into personal computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, server-side e-book provision process 10′ may reside on and be executed by server computer 20, which may be coupled to network 16. Examples of server computer 20 may include, but are not limited to: a single server computer, a series of server computers, a mini computer, and a mainframe computer, for example. Server computer 20 may execute a network operating system, examples of which may include but are not limited to: Microsoft Windows XP Server™; Novell Netware™; or Redhat Linux™, for example.

Server computer 20 may execute a web server application, examples of which may include but are not limited to: Microsoft IIS™, Novell Webserver™, or Apache Webserver™, that allows for HTTP (i.e., HyperText Transfer Protocol) access to server computer 20 via network 16. Network 16, and/or server computer 20, may be coupled to one or more secondary networks (e.g., network 22), examples of which may include but are not limited to: a local area network; a wide area network; or an intranet, for example.

The instruction sets and subroutines of server-side e-book provision process 10′, which may be stored on a storage device 24 coupled to data server 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the e-book provision process may be a client-side application (e.g., client-side e-book provision process 10), a server-side application (e.g., server-side e-book provision process 10′), or a hybrid client-side/server-side application (e.g., using portions of both client-side e-book provision process 10 and server-side e-book provision process 10′). Accordingly, the manner in which the e-book provision process is accessed may vary depending upon, at least in part, whether the e-book provision process is a client-side application, a server-side application, or a hybrid client-side/server-side application.

While not shown, client-side e-book provision process 10 may be associated with a variety of computing devices, e.g., notebook computer 32, laptop computer 34, and personal digital assistant 36, for example, in addition to personal computer 12. As described above, the instruction sets and subroutines of client-side e-book provision process 10, which may be stored on a storage device (e.g., storage devices 40, 42, 44) coupled to the computing device (e.g., notebook computer 32, laptop computer 34, and personal digital assistant 36, respectively), may be executed by one or more processors (not shown) and one or more memory architectures (not shown) incorporated into the computing device. Storage devices 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

If a client-side application, one or more users (e.g., users 14, 26, 28, 30) may access the client-side e-book provision process 10 directly through the computing device on which the client-side e-book provision process 10 is executed. Alternatively, server-side e-book provision process 10′ may be accessed by users 14, 26, 28, 30 through network 16 or through secondary network 22. Server computer 20 (i.e., the computer that executes server-side e-book provision process 10′) may be coupled to network 16 through secondary network 22, as illustrated with phantom link line 38.

The computing device (e.g., personal computer 12, notebook computer 32, laptop computer 34 and personal digital assistant 36) may execute a client application (e.g., client application 46 shown associated with personal computer 12) to access server-side e-book provision process 10′. The client application (e.g., client application 46) may be, for example, a web browser (e.g., Microsoft Internet Explorer™ and Netscape Navigator™, for example) that may interface with server-side e-book provision process 10′ and facilitate the bidirectional transfer of data between the computing device (e.g., personal computer 12) and server computer 20.

Additionally/alternatively, client-side e-book provision process 10 may be accessed by a user (e.g., user 14, 26, 28, 30) using a client application (e.g., client application 46). In such an embodiment, client-side e-book provision process 10 may be a stand-alone application that may interface with client application 46, or may be a plug-in or applet, that may be executed and/or accessed in the environment of client application 46.

Personal computer 12, notebook computer 32, laptop computer 34, and personal digital assistant 36 may each execute an operating system, examples of which may include but are not limited to Microsoft Windows™, Microsoft Windows Mobile™, Redhat Linux™, or a custom operating system.

The various computing devices (e.g., personal computer 12, notebook computer 32, laptop computer 34, and personal digital assistant 36) may be directly or indirectly coupled to network 16 (and/or to network 22). For example, personal computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows, e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### E-Book Provision Process:

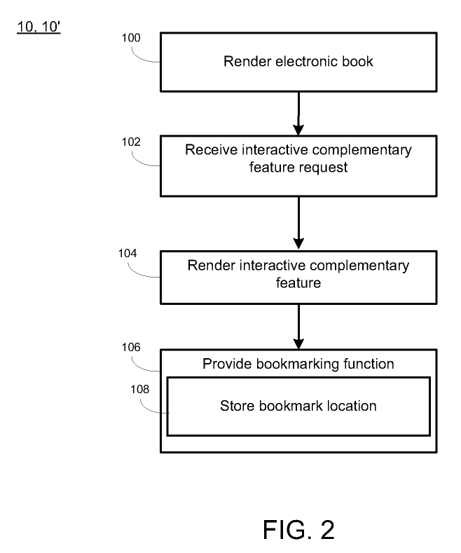

Referring also to FIG. 2, e-book provision process 10, 10′ may render 100 an electronic book, e.g., on a display screen associated with a computing device (e.g., computing device 12). Additionally, e-book provision process 10, 10′ may receive 102 an interactive complimentary feature request (e.g., from user 14 accessing the e-book via computing device 12). E-book provision process 10, 10′ may render 104 at least on interactive complementary feature related to at least a portion of a content of the electronic book in response to the received 102 request for the interactive complementary feature.

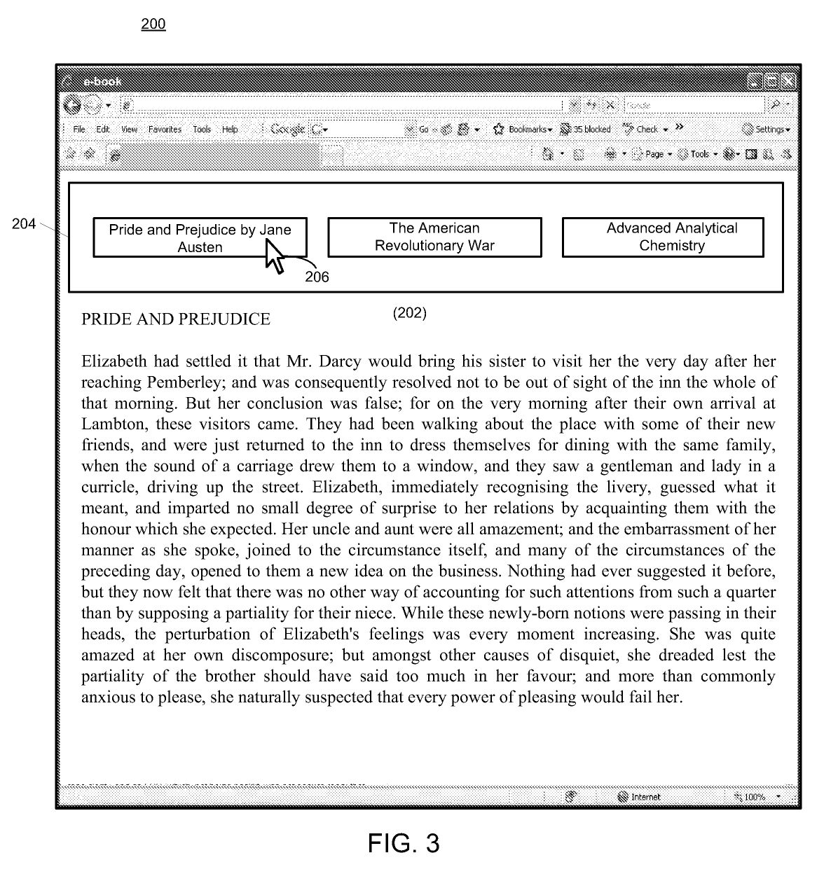

For example, and referring also to FIG. 3, e-book provision process 10, 10′ and/or client application 46 may render 100 user interface screen 200. User interface screen may include electronic book display region 202 (e.g., rendered by e-book provision process 10, 10′ and/or client application 46). Continuing with the above-stated example, user interface screen 200 may also include list 204 of available electronic books. List 204 of available electronic books may include a user-specific list of electronic books (e.g., which may include electronic books assigned to a student by a teacher, books from a predefined reading list, or merely a list of those electronic books available to the user). Using onscreen pointer 206 controlled by a pointer device (e.g., a mouse; not shown), user 14 may select an available electronic book from list 204. E-book provision process 10, 10′ and/or client application 46 may render 100 the selected electronic book, namely “Pride and Prejudice” in the illustrated embodiment of FIG. 3, in the electronic book display region 202 of user interface screen 200.

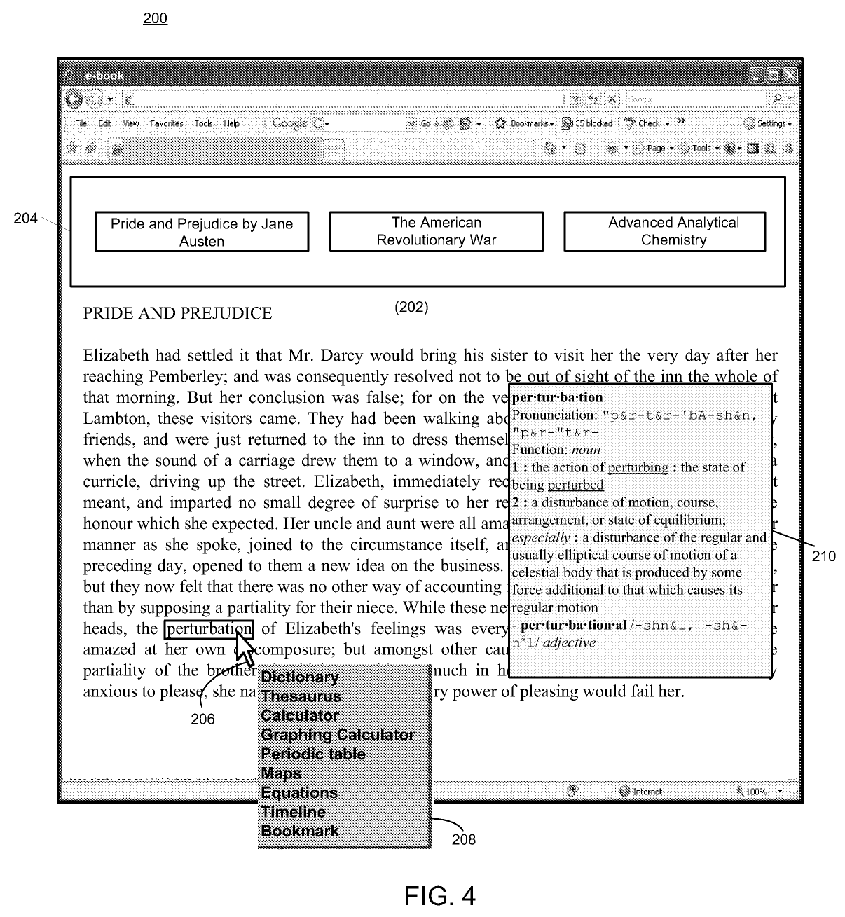

E-book provision process 10, 10′ may provide at least one interactive complementary feature related to at least a portion of a content of the electronic book and the at least one interactive complementary feature may be accessible to the user. Continuing with the above-stated example, and referring also to FIG. 4, while reading “Pride and Prejudice” (i.e., a work of literature) e-book provision process 10, 10′ rendered in electronic book display region 202 of user interface screen 200, user 14 may come across a word that he/she does not recognize. Using onscreen pointer 206 user 14 may select the unrecognized word (e.g., perturbation), for example by placing onscreen pointer 206 on the unrecognized word and right-clicking.

Right-clicking may result in e-book provision process 10, 10′ and/or client application 46 rendering interactive complementary feature menu 208 including a listing of available interactive complementary features. For example, interactive complementary feature menu 208 may include a listing of available interactive complementary features, namely, a dictionary, a thesaurus, a calculator, a graphing calculator, a periodic table, a timeline, a map or set of maps, one or more tables of equations, and bookmarking. Various other interactive complementary features will be readily understood, and may have varying applicability depending upon, at least in part, the subject matter of the electronic book accessed by the user. Continuing with the above-stated example in which user 14 has come across an unrecognized word (i.e., perturbation) while reading an electronic book. User 14 may select, via onscreen pointer 206, “Dictionary” from interactive complementary feature menu 208. e-book provision process 10 may receive 102 the request for the interactive complementary feature “dictionary. Responsive to the received 102 request for the interactive complementary feature “dictionary”, e-book provision process 10, 10′ and/or client application rendering dictionary entry 210 including the selected work “perturbation.” Dictionary entry 210 may, for example, provide a definition for the word “perturbation,” as well as a pronunciation guide, word function, etc.

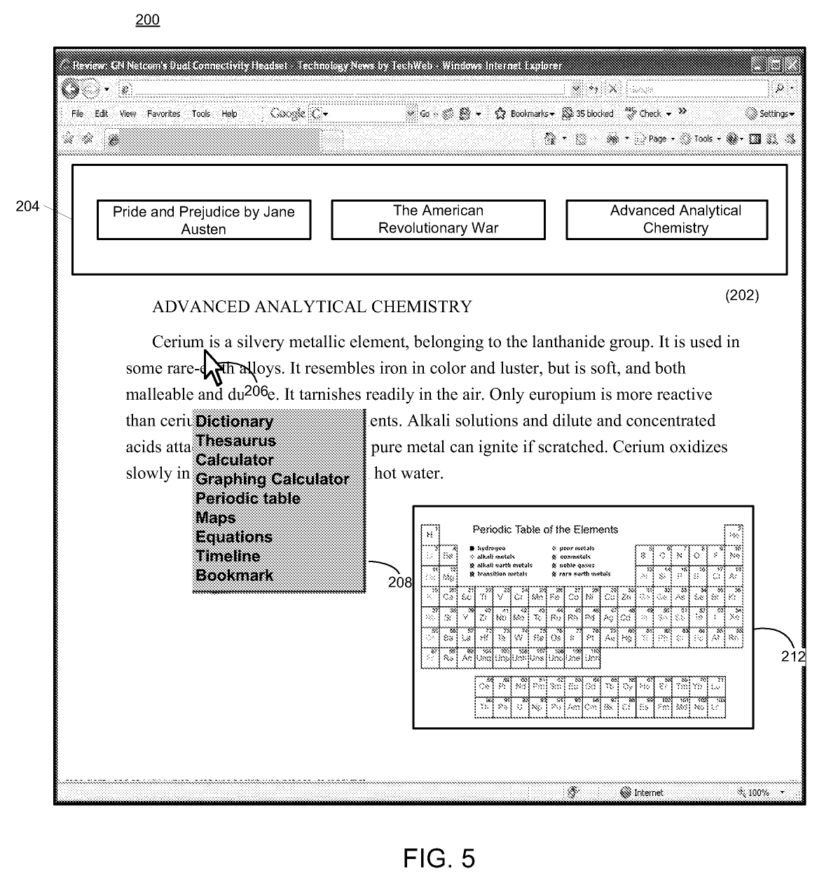

Continuing with the above example and referring also to FIG. 5, the electronic book rendered in electronic book display region 202 may relate to chemistry (e.g., may be an electronic book on Analytical Chemistry). User 14 may desire additional information regarding the element “Cerium” mentioned in the analytical chemistry electronic book. As such, user 14 may right-click on the word “Cerium” in the analytical chemistry electronic book using onscreen pointer 206. Right-clicking on the word “Cerium” may result in e-book provision process 10, 10′ and/or client application 46 rendering interactive complementary feature menu 208. User 14 may select, using onscreen pointer 206, the interactive complementary feature “Periodic Table” in interactive complementary feature menu 208, resulting in e-book provision process 10, 10′ receiving 102 a request for a periodic table interactive complementary feature. In response to receiving 102 the request for the periodic table interactive complementary feature, e-book provision process 10, 10′ and/or client application 46 may render 104 periodic table 212, for example, in electronic book display region 202 of user interface screen 200.

As described above, e-book provision process 10, 10′ may receive 102 a request for a interactive complementary feature based upon, at least in part, a content of the electronic book rendered 100 by e-book provision process 10, 10′ and/or client application 46. Responsive to the received 102 request for a interactive complementary feature, e-book process 10, 10′ and/or client application 46 may render 104 the requested interactive complementary electronic feature. Various other interactive complementary features (e.g., a calculator, a graphing calculator, tables of equations, maps or sets of maps, timelines, and the like) may be rendered 104 in a corresponding manner, depending upon, at least in part, the content of the electronic book being consumed (e.g., the electronic book rendered 100 by e-book provision process 10, 10′ and/or client application 46). Additionally, more than one interactive complementary feature may be capable of being rendered 104 for any given electronic book. For example, in the context of the electronic book relating to analytical chemistry, in addition to the illustrated and described periodic table, a user may desire to use a calculator (e.g., for calculating molar masses, stoichiometric ratios, and the like). Similarly, a user may utilize a dictionary, e.g., to get a definition of an unrecognized or unknown word.

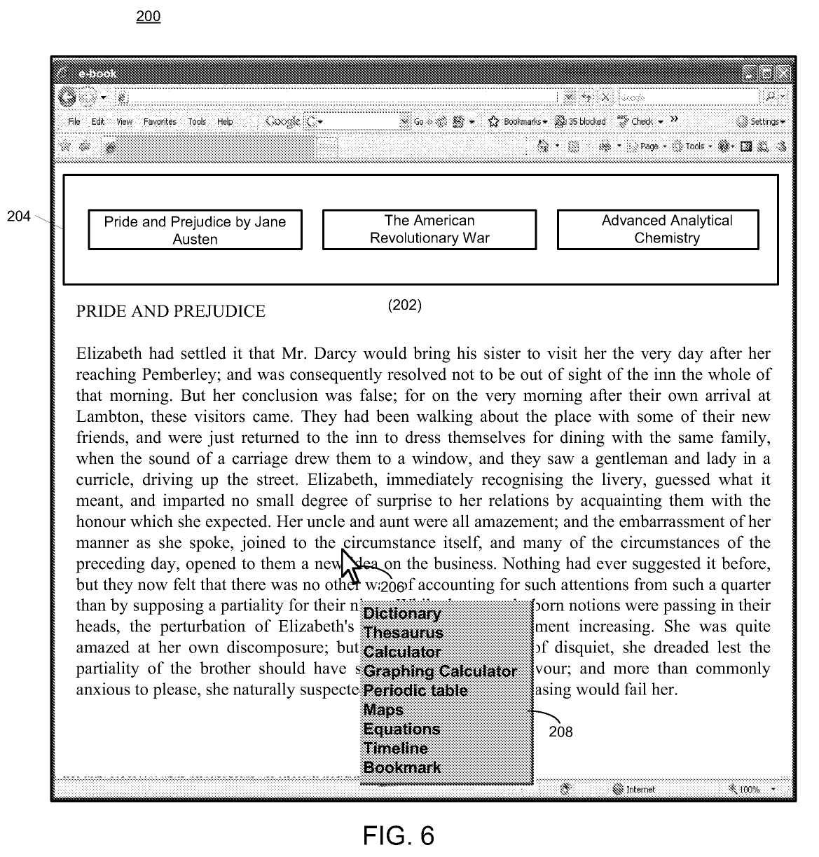

Continuing with the above-stated example, e-book provision process 10, 10′ may also provide 106 a bookmarking function. The bookmarking function provided 106 by e-book provision process 10, 10′ may enable a user to bookmark a stopping point in an electronic book (e.g., an electronic book rendered 100 in electronic book display region 202 of user interface screen 200). Bookmarking the stopping point in the electronic book may allow the user to easily return to the stopping point at a later time. Continuing with the above-stated example, and referring also to FIG. 6, user 14 may select, e.g., via onscreen pointer 206, a desired stopping point. The desired stopping point may be a point to which user 14 may wish to return during a subsequent reading session. User 14 may right-click (e.g., using the pointing device; not shown) resulting in e-book provision process 10, 10′ and/or client application 46 rendering interactive complementary feature menu 108. User 14 may select, e.g., using onscreen pointer 106, “Bookmarking” option from interactive complementary feature menu 108. E-book provision process 10, 10′ may store 108 the bookmarked location.

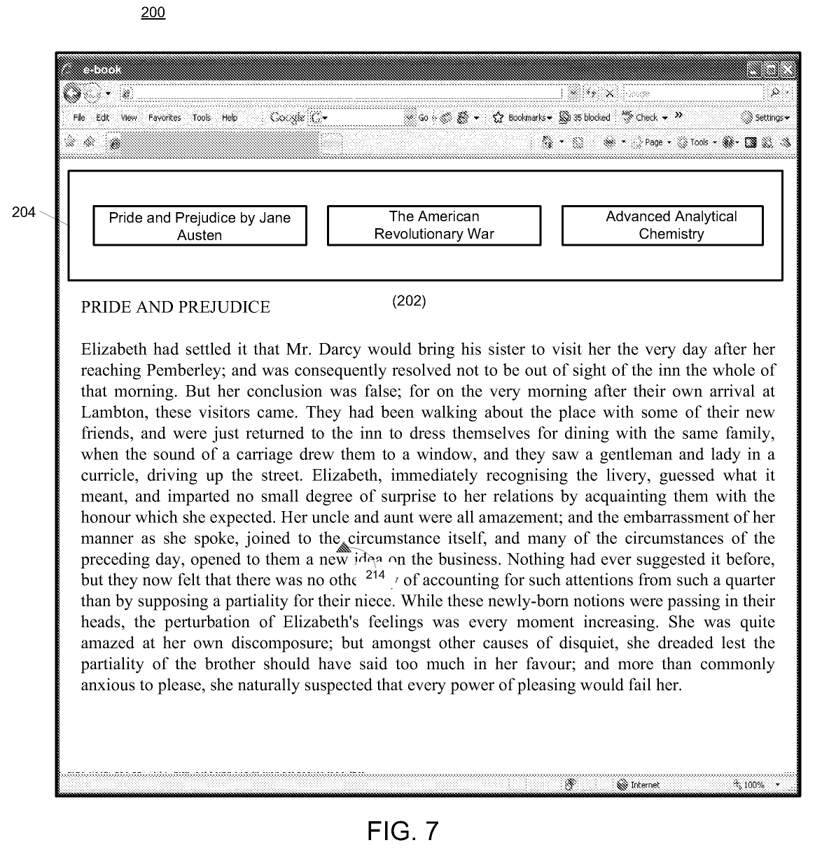

Continuing with the above-stated example, and referring also to FIG. 7, when user 14 subsequently returns to the electronic book “Pride and Prejudice” (e.g., by subsequently selecting “Pride and Prejudice” from list 204 causing e-book provision process 10, 10′ and/or client application 46 to render the electronic book “Pride and Prejudice” in electronic book display region 202 of user interface screen 200), e-book provision process 10, 10′ and/or client application 46 may display a portion of the text of the electronic book “Pride and Prejudice” including the bookmarked portion of the text. Additionally, e-book provision process 10, 10′ and/or client application 46 may display bookmark 214. Bookmark 214 may indicate the exact location selected by user 14 for bookmarking. As such, user 14 may return to reading the electronic book at the exact portion that was previously bookmarked. Bookmark may persist in the electronic book until another bookmark is created by user 14, until the next time the electronic book is viewed, for a predetermined period of time, or other suitable time period.

A number of implementations have been described. Nevertheless, it will be understood that various modifications may be made. Accordingly, other implementations are within the scope of the following claims.

What is claimed is:

1. A system comprising:
an electronic book viewable by a user; and
at least one interactive complementary feature related to at least a portion of a content of the electronic book, the at least one interactive complementary feature accessible to the user.

2. The system of claim 1, wherein the electronic book is selected from a user-specific list of electronic books.

3. The system of claim 1, wherein the at least one interactive complementary feature is selected from the group consisting of a calculator, a graphing calculator, a dictionary, a thesaurus, a periodic table, a timeline, a map, a set of maps, and a table of equations.

4. The system of claim 1, wherein the at least one interactive complementary feature is selected from a list of interactive complementary features related to at least a portion of the content of the electronic book and accessible to the user.

5. The system of claim 1, further comprising a bookmarking function, the bookmarking function enabling a user to bookmark a stopping point in the electronic book for returning to at a later time.

6. A method comprising:
rendering an electronic book on a display screen of a computing device;
receiving an interactive complementary feature request from a user; and
rendering at least one interactive complementary feature related to at least a portion of a content of the electronic book in response to the interactive complementary feature request.

7. The method of claim 6, wherein the electronic book is selected from a user-specific list of electronic books.

8. The method of claim 6, wherein the at least one interactive complementary feature is selected from a list of interactive complementary features related to at least a portion of the content of the electronic book and accessible to the user.

9. The method of claim 6, wherein the at least one interactive complementary feature is selected from the group consisting of a calculator, a graphing calculator, a dictionary, a thesaurus, a periodic table, a timeline, a map, a set of maps, and a table of equations.

10. The method of claim 6, further comprising providing a bookmarking function, the bookmarking function enabling a user to bookmark a stopping point in the electronic book for returning to at a later time.

11. A computer program product residing on a computer readable medium having a plurality of instructions stored thereon which, when executed by a processor, cause the processor to perform operations comprising:
rendering an electronic book on a display screen of a computing device;
receiving an interactive complementary feature request from a user; and
rendering at least one interactive complementary feature related to at least a portion of a content of the electronic book in response to the interactive complementary feature request.

12. The computer program product of claim 11, wherein the electronic book is selected from a user-specific list of electronic books.

13. The computer program product of claim 11, wherein the at least one interactive complementary feature is selected from a list of interactive complementary features related to at least a portion of the content of the electronic book and accessible to the user.

14. The computer program product of claim 11, wherein the at least one interactive complementary feature is selected from the group consisting of a calculator, a graphing calculator, a dictionary, a thesaurus, a periodic table, a timeline, a map, a set of maps, and a table of equations.

15. The computer program product of claim 11, further comprising instructions for providing a bookmarking function, the bookmarking function enabling a user to bookmark a stopping point in the electronic book for returning to at a later time.
